(19) United States
(12) Patent Application Publication
(10) Pub. No.: US 2006/0196945 A1
(43) Pub. Date: Sep. 7, 2006

(54) Identification device, anti-counterfeiting apparatus and method

(76) Inventor: David A. Mendels, Middlesex (GB)

Correspondence Address: DEWITT ROSS & STEVENS S.C., 8000 EXCELSIOR DR, SUITE 401, MADISON, WI, 53717-1914, US

(21) Appl. No.: 10/533,375

(22) PCT Filed: Oct. 30, 2003
(86) PCT No.: PCT/GB03/04676

§ 371 Date: Feb. 13, 2006

(30) Foreign Application Priority Data
Oct. 30, 2002 (GB) 0225290.6

(51) Int. Cl. G06K 7/10; G06K 19/00

(52) U.S. Cl. 235/470; 235/487

(57) ABSTRACT

The preferred embodiment provides a 3D nanometer scale data encryption key. It consists in using 3D polymer patterns on silicon substrates as evolved, tri-dimensional barcodes. It provides several possible degrees of encryption which, together with the high technology involved, makes it virtually impossible to counterfeit. There is described the basic geometry, the process, the coding principles through such structures, and the reading principles. The preferred geometry is that of an array of lines, similar to a barcode when seen from above, with the difference that lines have dimensions in the tens of nanometer range. These lines are preferably made of a cross-linked, modified Poly(methyl methacrylate). Cross-linking by ultra-violet light gives them an exceptional mechanical durability for structures of this size.

The present invention relates to apparatus and a method for providing anti-counterfeiting features to security articles, such as security paper, banknotes and the like. The present invention also relates to an identifier for identifying articles and the like.

In the field of document and article security, it has been known for a long time to provide security devices in the articles to be protected, in which devices are intended to act as a verification tool for verifying the authenticity of the article and also as a deterrent to deter would-be counterfeiters, achieved by the apparent difficulty in reproducing the security device. Examples are the metal thread provided within banknotes, watermarking, holograms and so on. A general problem with such security devices is that over time would-be counterfeiters are either able to duplicate the device or are able to counterfeit the device sufficiently well that others can be fooled into believing that the security device itself is genuine and therefore that the article is also genuine. For example, it has been known to replicate the metallic thread incorporated in banknotes by a coloured ink or even by a pencil mark on the top surface of the paper product. In the case of cashiers, at a bank or at a shop, such measures have on occasions proven successful in fooling the cashier into accepting a counterfeit banknote or cheque.

The present invention seeks to provide an improved security device, improved apparatus for detecting such a device, and as a result of detecting the authenticity of articles, and a new identification device.

According to an aspect of the present invention, there is provided an identification device including first and second machine-readable identification codes arranged along different dimensional axes to one another.

Advantageously, the first and second identification codes are located substantially orthogonal to one another.

In the preferred embodiment, there is provided a third identification code arranged in a direction different from the directions of the first and second codes.

Most preferably, there is provided a fourth identification code which has a physical characteristic different from that of the first, second and third codes (where the latter is provided). This different physical characteristic may be a different chemical composition, electrical characteristic, magnetic characteristic, colour or texture.

Advantageously, the identification device has dimensions of the order of micrometers or less in at least one direction. Most preferably, the device has dimensions of the order of micrometers or less in at least two directions. The preferred embodiment has coding units of the order of nanometers in at least one and most preferably two directions.

The advantage of the complex identification codes (that is in at least two directions) disclosed herein provide many orders of magnitude of codes greater than a simple one-dimensional code of the type used in conventional barcodes. A three or four dimensional code of the type disclosed herein can provide such a large number of configurations that it is practically impossible to break the encoding with existing computer processing systems.

The advantage of a coding system having the dimensions given herein is that it becomes very difficult for would-be counterfeiters to manufacture the identification device and even harder to duplicate the device. This can make it particularly advantageous when used as a security device for high value items, such as banknotes and other security paper, artworks, jewellery, gem stones and so on.

According to another aspect of the present invention, there is provided a security device for an article, including a coded item having coding units of the order of nanometers in at least one dimension.

The coded item may be a barcode and the coding units may be individual bars of the barcode. Advantageously, the coded item provides a code in at least two dimensions, most preferably in at least three dimensions.

According to another aspect of the present invention, there is provided a security device for an article including a coded item providing a two-dimensional security code.

Most preferably, the coded item provides a three-dimensional security code.

According to another aspect there is provided a security device designed for provision on or in a currency banknote or other security paper.

According to another aspect of the present invention, there is provided detection apparatus for detecting an identification or security device of the type disclosed herein, including means for locating a device on an article and at least one reading means, wherein the reading means includes an atomic force microscope or other micro computerised measuring machine.

Embodiments of the present invention are described below, by way of example only, with reference to the accompanying drawings, in which:

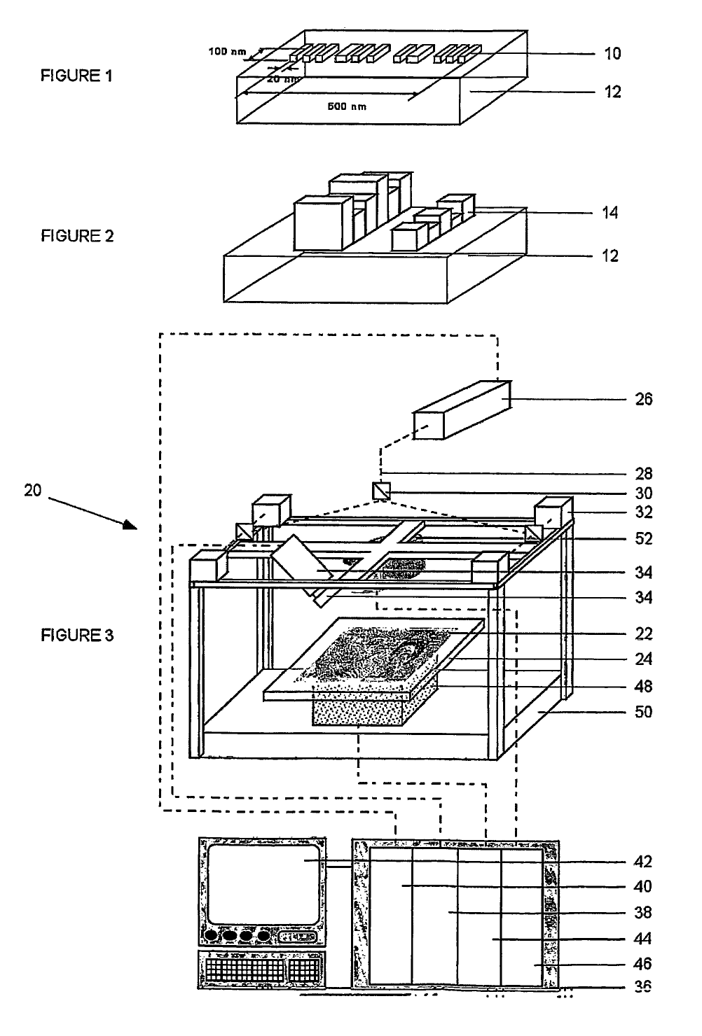

FIG. 1 shows a perspective view of an embodiment of polymer nano-barcode element;

FIG. 2 shows a perspective view of an embodiment of three and a half-dimensional polymer nano-barcode element; and

FIG. 3 shows an embodiment of device reader suitable for reading the devices of FIGS. 1 and 2.

The embodiments described below provide a security device having nanometer dimensions which can be used on high value items, such as banknotes and other security paper, works of art, jewellery, gem stones as well as other articles which may require secure identification, such a medicaments.

The preferred embodiments provide a device which is hard or impossible to detect with the naked eye and which is hard to manufacture without appropriate equipment and hard or virtually impossible to duplicate.

Furthermore, the preferred embodiments provide a device having potentially such a total number of possible codes that it becomes virtually impossible to identify the correct code by trial and error.

In a practical embodiment, it is envisaged that such a security device could be fitted on or incorporated into a banknote or other security paper and be detectable only by appropriate automated detection not requiring human input in terms of detection. This has the advantage of preventing incorrect identification of the security device, for example by a cashier simply assuming that the banknote is genuine by simple location of the security device. As the devices cannot be seen or are extremely difficult to see with the naked eye, such an error could not be made.

The preferred embodiment provides a 3D nanometer scale data encryption key. It consists in using 3D polymer patterns on silicon substrates as evolved, tri-dimensional barcodes. It provides several possible degrees of encryption which, together with the high technology involved, makes it virtually impossible to counterfeit. There is described the basic geometry, the process, the coding principles through such structures, and the reading principles.

The preferred geometry is that of an array of lines, similar to a barcode when seen from above, with the difference that lines have dimensions in the tens of nanometer range. These lines are preferably made of a cross-linked, modified Poly(methyl methacrylate). Cross-linking by ultra-violet light gives them an exceptional mechanical durability for structures of this size.

Referring to FIG. 1, there is shown an embodiment of security device which in this example is in the form of a two-dimensional barcode (the term “two-dimensional” is explained in detail below). In this example, the barcode 10, which is formed of a polymer material as is described in further detail below, is formed on a substrate 12 and has a length of around 500 nanometers. Each individual coding element of the barcode 10 has, in this example, a length in the region of 100 nanometers and a width of the order of tens of nanometers, in the example shown, the first coding element having a width of 20 nanometers.

Referring to FIG. 2, there is shown an embodiment of a more complex barcode, that is what could be termed a three and a half-dimensional coding scheme. In this example, in which the barcode has dimensions of the same order as the example of FIG. 1, is coded both in what could be termed a longitudinal direction of the codes, indicated by arrow X and is in a transverse direction in what could be termed a direction Y, along the length of each individual coding element. In FIG. 2, only two coding elements of the barcode 14 are shown but it will be understood that there will be a series of these coding elements, similar to the example of FIG. 1 and to conventional barcodes.

It is envisaged that coding elements of different complexities could be used for the security device, principally as follows.

Two-Dimensional

This is a simple barcode in which the width only of each coding element is read and the bar coding can be carried out using fine barcode fonts.

Two and a Half Dimensional Code

This is similar to the two-dimensional barcode but in which two side-by-side codes are provided whose widths only are read. This could be considered a fragmented barcode providing two or more codes, depending upon the number of individual barcodes provided.

Three-Dimensional Codes

This becomes a more complex code and therefore useful for higher security applications. As in the example shown in FIG. 2, both the width and the height of the coding elements are used to produce two distinct codes. That is, width of one of the coding strips can be varied relative to the width of the other coding strips and the barcode, while the heights can be varied also. In addition, the height of each coding strip can be different with respect to the other coding strips on the barcode so that differences in height produce a second code.

This has obvious advantages for a cryptographer, in that information can be coded on one dimension, for example the width, while the keys for decryption is carried by the other dimension, for example the height of the coding elements. In practice, only half of the key may be provided in the code itself, with the other half being kept in possession of the manufacturer of the code. This expands the coding possibility to almost infite, since the information coded on 128 bits could be recorded using another 128-bit key. In a sense, the coding is expanded exponentially if compared to classical binary coding.

Moreover, the size of the coding elements of the preferred embodiments described herein makes it extremely difficult for third parties to produce a counterfeit security device. For example, the counterfeiter would need to appreciate that the third dimension (the height) does actually represent a code rather than variations due to manufacturing tolerances. If this is assumed, a would-be counterfeiter would have to be able to reproduce such a security device, which would be extremely difficult. Suitable apparatus is not readily available and would be of such expense and complexity that it would not be practicably feasible.

On the basis that the code cannot be reproduced by simple duplication, this provides another capability, taken from an early banking verification system. The system, provided a coded element (typically a strip of wood having slits therein) which was split in half, with the bank keeping one and the client the other. With the coding system described herein, a similar arrangement can be achieved.

Three and a Half Dimensional Code

The tag could be considered another half dimension to the three-dimensional code described above, the height along each coding element is also varied, as shown in the example of FIG. 2. Thus, each coding element provides a code embedded solely therewithin, not only a code which can be determined with reference to the other codes or to another dimension of each coding element.

In practice, this additional coding corresponds to the steps and height or a slanted shape, (which can be continuous or discontinuous) in each coding element. Each level of complexity carried by the code increases the number of combinations almost exponentially, so that it is not likely to be broken. It could be considered as encrypting a key which itself encrypts the information.

Four-Dimensional Code

Additional coding can be provided by giving each coding element a specific physical characteristic which can be measured. One example is to imprint functional materials, such as PVDF based polymer (piezoelectric) or polyaniline (conductive) material and to add the piezoelectric or conductive response to the code itself. Other functional physical characteristics could include magnetism, colour and so on.

The code could be read by an additional reader, such as a piezoelectric reader, a conductive sensor, a light sensor or the like. Additional coding could be provided by varying this physical characteristic along the length of each coding element (in a similar way to the three and a half dimensional coding described above).

It will be appreciated that by adding extra dimensions or half dimensions to the code, this in effect creates additional encryption which makes it harder and harder to break the code. In a number of the examples described above, the coding is such as to be practicably unbreakable by means of current computing capabilities and foreseeable future capabilities such as quantum computers.

Although barcodes are described above and shown in FIGS. 1 and 2, the principles are not restricted to barcodes or to any code in the shape of a line. In fact, any shape produced which is machine readable could be used. For example, a coding element could be produced from dots and pits within a substrate. The points could be equally or unevenly spaced on a surface and used to provide the coding.

Location of the Code

Given the fact that the security device of the type contemplated in FIGS. 1 and 2 is very small (in the preferred embodiment in the range of nanometers or micrometers) it makes it very difficult or virtually impossible to locate with the naked eye. This allows a security device to be placed anywhere on the article to be protected, with a first level of security simply being having to locate the device in the first place. Seeking to locate the device as in, for example, an optical microscope is likely to be a very time consuming task given the likely size of the article relative to the security device.

Manufacture

In the preferred embodiment, the substrate is formed from a semi-conductor wafer, such as silicone or germanium, or any other material which does not reflect a particular radiation. The advantage of this is that the material does not reflect infrared radiation, allowing the device to be located by means of one or more infrared lasers, suitable pick-up device such as a CCD camera and suitable processing equipment (typically a computer). Such equipment is specialist in nature and not readily available in the format that would be required for locating the device by, for example, a would-be counterfeiter. Of course, the entity applying the device to an article can make a record of the approximate location of the device in the article to facilitate its detection for reading purposes.

Thus, the security device is hard to copy by a would-be counterfeiter. Moreover, this has an important advantage with respect to verification of the article because users, such as cashiers in the case of coded banknotes, cannot simply visually locate the security device and then assume that the banknote is genuine but must make use of automated detection equipment, an example of which is described below.

The structure is preferably processed from a polymer film spun on a silicon substrate of about 20 μm in thickness. In that dimension range, silicon has a flexibility comparable to that of paper and yet retains all its physical properties. The polymer layer is imprinted by a mask having characteristic details in the tens of nanometre range, a chemical route is then used to dissolve partly the polymer so that lines of various dimensions are left on the substrate. These are further cross-linked by ultra-violet light.

The other side of the silicon wafer is chemically treated by a silane, whose function is to provide enhanced adhesion to the destined object, a banknote for the example. A large number of quasi identical structures is produced on the wafer, they are further severed by a cutting step. This step is preferably realised by water jet guided laser cutting. The resulting silicon+polymer marker artefact has typical dimensions of 50×5×20 μm³, typically in the range of well-cut beard hair.

The primary material choice for generating nano-patterns using nano-imprint lithography is generally thermoplastic polymers, although the thermal stability of the patterns obtained is relatively low. This disadvantage is overcome with cross-linkable pre-polymers. In addition, to good thermal stability, the nano-patterns generated are highly resistant to chemicals and stable to dry etching. As the cross-linked polymer layers do not dissolve in organic solvents, they can in principle advantageously be used to build up multi-layered systems.

The polymer used was a modified poly-methyl methacrylate (PMMA) provided by MicroResist Technology (MRT GmbH—Germany), named mrL6000. Films about 100 nm thick were obtained by spin coating onto a RCA cleaned silicon substrate, oriented in the (111) direction. The films were baked at 120° C. for 180 s, in order to remove the solvents. In order to achieve structuring behaviour which can be both checked and reproduced, the layers were processed immediately after the baking process. The features were written on a 2×2 cm² square specimen using a Philips XL 30S FEG SEM equipped with a RAITH lithography module. For exposure the following conditions were chosen: accelerating voltage 30 kV, dose 5 μC/cm². After exposure the resist was developed for about 30 s in a standard 4-methyl-2-pentanone:2-propanol (1:3) developer. The structure was further exposed to ultra-violet light for 120 s and post-cured at 120° C. for 300 s. In order to achieve structures with a reproducible and homogenous surface state, the electron-beam lithography processing route was preferred, although it has been demonstrated that such structures are easily obtained by nano-imprint lithography (NIL) but the surface topology may vary from location to location. In fact, the technology used is typical of that used to produce masks which will be used to imprint into the polymer (one additional processing step for the production of a mask is the application of a metallic coating to the polymeric pattern). Moreover, such NIL structures can be transferred efficiently to other structures with a high fidelity (M. Li, L. Chen, W. Zhang, and S. Y. Chou, “Pattern transfer fidelity of nanoimprint lithography on six-inch wafers”. Nanotechnology, 14:33-36, 2003).

The polymer line can be shaped in three dimensions, which means that they can be made in a slanted paramador shape. This introduces several advantages, among which are: (1) the lines are difficult to reproduce (only direct contact will allow duplication or measurement by means of a scanning probe method and production using the same technique) and (2) the location of where to start to read the code is facilitated. It is sufficient to read six points to know in which plane the reading tip of the reader should start the reading. This is described in further detail below.

The materials from which the security device could be made are not simply restricted to those proposed above, that is a silicon substrate and a more physical cross-linked polymer. In fact it is very much possible to produce such security devices using other materials. One example is float glass or quartz or even polymer or metal for the substrate and/or coding elements of the device. An alternative which has been found to be particularly effective is a substrate of GaAs which is optically flat and which absorbs in one wavelength. Similarly, the coding elements could be formed from nano-patterned metals, photoresist materials, semiconductors and so on. Most materials can be considered, provided that they can be obtained with adequate flatness, for example with an atomic roughness.

The preferred embodiment of security device can adhere automatically to an object. More particularly, in the case of banknotes and other security paper, most papers undergo a chemical process to be whitened which inevitably leaves some residue. In a simple case, the paper may be cleaned using an ammonia, in which case a epoxy-class silane can be used for the following reasons. The silane naturally forms a chemical bond with silicone and the epoxy function will react with the NH groups that are retained as residue in the paper. In this way, a set of covalent and Van der Wall bonds can be formed spontaneously and provide maximum adhesion without the need for glue. In light of the wide range of silanes available on the market, this approach can be generalised to other materials. The device can even be included in the processing of plastic materials, for example during the curing of a thermoset material or in the liquid state of a thermoplastic material (the high viscosity in liquid state would allow the device to float on the surface).

Of course, any suitable method for adhering the device to the article in which it is to be applied can be used. The same applies with the manufacturing process for manufacturing the device in the first instance. Some examples of new processes are nano-imprint lithography, hot embossing, cold embossing, UV curing during embossing, cold embossing in metal and direct embossing in silicon.

Once the coding elements (the pattern) have been produced on the substrate, there are several ways to ensure very high difficulty in reproducing the substrate. In one case, surface tension is used to protect the code from easy duplication. To achieve this, two routes are possible; the chemical route and the physical route. The chemical route consists in modifying the composition of the polymer so that it cannot be wetted by most known polymers in its solid state. The targeted materials that could be used are, for example, PDMS and all its derivatives, as well a Teflon-based materials. The second route makes use of the extremely small size of the nano-lines. It is possible to make them so small and so close that they appear as an “ordered” roughness which does not let them to be wetted by any liquid having a viscosity larger than a certain value. The value of this viscosity can be tailored by the value of the roughness, such that the code can only be produced therefore by an original manufacturing process.

Location and Detection

Once the security device has been applied to an article, as described above, it is very difficult and in some cases almost impossible to locate by the naked eye. For this purpose, it is preferred that an automatic device location system is provided, in a detection device.

Briefly, in one embodiment, the location and reading of the key basically proceeds in two steps. First, the micrometer artefact is located on the banknote, by using a laser in the infra-red range (silicon being a semi-conductor absorbs in the red). A high resolution charge-coupled device (CCD) camera fitted with an infrared filter is used to detect the reflection of the silicon and gross co-ordinates are obtained. Second, these co-ordinates are used to position an atomic force microscopy-type device, which will read the 3D information carried by the polymer lines. The polymer lines have a pyramid slanted pyramid shape, and bear a single or double encryption. Single encryption corresponds to a barcode, and lines of alternated width define a code of up to 128-bits, practically, although this could be extended. This code cannot be broken by modern computers in a reasonable time, and is changed according to the life of the stamp, that is approximately once every ten to hundred thousand with current NIL.

In the case of coding elements which have a slanted shape, the AFM tip can be positioned at the upper right corner of the 3D barcode. It then makes two readings, the first one from left to right of the bar width at ⅓ from the top of the structure, and on the way back (from right to left), the height is recorded at a position of ⅔ of the structure. This allows the structure formed by the polymer lines to bear a double 128-bit encryption key, defined by the width and the height of the structure. For more complex devices, such as that shown in FIG. 2, the entirety of the coding elements must be read.

In more detail, FIG. 3 shows an embodiment of location and detecting device for detecting and reading the code for one of the security devices of the type disclosed above and shown with reference to FIGS. 1 and 2.

The device provides an enclosure 20 within which (in this example) a banknote 22 is placed. In the embodiment shown, the banknote is placed on a suction table 24 which has the purpose of sucking the banknote 22 onto the surface of the suction table so as to keep it as flat as possible for the detection process. An infrared laser source 26 provides an infrared laser beam through an optical fibre 28, which is then split into four paths by beam splitters 30 and divergent mirrors 32. A high resolution CCD camera 34 is located so as to receive the infrared light reflected of the banknote 22 and is coupled to a processor 36 for processing of the gross co-ordinates of the image. For this purpose, the processor 36 is provided with an image acquisition card 38, a laser control card 40 and a computer control unit 42. It is also provided with a nano -positioning control card 44 and with an AFM control card 46, both of which are described in further detail below.

In the embodiment shown, the suction table 24 is mounted to a three-dimensional nano-positioning device 48 which may, for example, be a NanoMax-HS™ (sold by Melles Griot).

The positioning device 48 is mounted to a stable base 50, which in this embodiment is a marble support table.

Also fitted to the frame is a portable atomic force microscope (AFM) 52.

In operation, a banknote or other security paper to be authenticated is passed into the housing 20 by any suitable mechanism (a banknote feeding mechanism may be provided of a type known in the art) which is then held to the suction table 24 by the suction produced thereby. An infrared light source is then created by the laser 26 which illuminates the surface of the banknote 22. The silicon substrate of the security device absorbs the infrared radiation and therefore does not reflect the infrared light beams originating from the divergent mirrors 32. Thus, the image obtained by the CCD camera 34 and processed by the image acquisition card 14 will show the area of non-reflection and therefore the location the security device.

The nano-positioning control card 44 then operates, under control of the computer control unit 42, to reposition the banknote 22 so that the security device is located directly under the tip of the AFM 52. The AFM tip is then controlled by the AFM control card 46 to detect the pattern of the nano-barcode. That pattern is then decrypted by the computer control unit to verify the authenticity of the device and therefore of the banknote itself. As explained above, the code could be encrypted using one of the known encryption algorithms.

Although the above-described embodiment uses a contact-based technique to read the width and height of the coding elements, it will be apparent that a non-contact-based technique could be used also. One example is a dual white light interferometer.

It is also envisaged that there could be included a transmitting property on the coding device itself. For example, it is possible in the case of bank cards to package the code together with an AFM-type device with a MEMS transmitter (e.g. Bluetooth type) and a microprocessor to control the elements of the device. The advantage of a physical-based interaction is the following. During the packaging operation it is easy to include a sprung element that is released upon opening the chip, thereby destroying it. Thus, the device can be secured against counterfeiting (in that it is impossible to reproduce because it is impossible to open). On the other hand, the signal emitted will be protected by encryption, which could use one of the well established “public key” mechanisms.

As explained above, the security device is not limited to banknote applications. It can be applied, in fact to any object suitable for bar coding. It can be used, for example to authenticate security documents, plastic bank cards, identification cards and even for the marking of pharmaceutical pills and other products to be ingested. For the latter, the composition of the device can be made bio-compatible so it can be digested without problems. Starch is one example.

The device could also be provided for fixing by a user to a high value item. One example might be a member of the public or art gallery wishing to secure a painting or sculpture. For this purpose, the security device could be provided on a suitable carrier, such as an adhesive strip or plaster (which assists in locating and placing the device on the article) with the strip or plaster then being removed to leave the device only secured to the article. Of course, considering the dimensions of the device, it is unlikely to be detected by a third party, particularly considering the fact that the article is likely to be a great many times larger than the security device. The gallery or owner of the article can keep a record of the location of the device and then, for the assistance of a security service in the reading of the device or authenticating the article at any point in the future. Such a service can be provided by a third party having reading equipment similar to that shown in FIG. 3 but adapted for the articles in question.

It is envisaged that in some applications the security device could be of much larger dimensions, while still providing the three-dimensional features described above.

1. An identification device including in a single coded layer first, second and third machine-readable identification codes arranged along length, width and height dimensional axes and each provided with coding elements extending along their respective dimensional axes.

2. An identification device according to claim 1, wherein the first, second and third identification codes are located substantially orthogonal to one another.

3. An identification device according to claim 1, wherein there is provided a fourth identification code which has a physical characteristic different from that of at least one of the first, second and third codes.

4. An identification device according to claim 3, wherein the different physical characteristic includes one of a different chemical composition, electrical characteristic, magnetic characteristic, color and texture.

5. An identification device according to claim 1, wherein the identification device has dimensions of the order of micrometers or less in at least one direction.

6. An identification device according to claim 1, wherein the device has dimensions of the order of micrometers or less in at least two directions.

7. An identification device according to claim 1, including coding units of the order of nanometers in at least one direction.

8. An identification device according to claim 1, wherein the device is not visible to the naked eye.

9. An identification device including first and second machine-readable identification codes arranged along different dimensional axes to one another, said first and second codes not being visible to the naked eye, and a further machine-readable identification code which has a physical characteristic different from that of the first and second codes.

10. A security device for an article, including on an exterior surface of the device a coded item having coding units of the order of nanometers in at least one dimension.

11. A security device according to claim 10, wherein the coded item is a barcode and the coding units are individual bars of the barcode.

12. A security device according to claim 10, wherein the coded item provides a code in at least two dimensions.

13. A security device according to claim 10, wherein the coded item provides a code within a single layer which includes first, second and third codes arranged along length, width and height dimensional axes.

14. (canceled)

15. (canceled)

16. An identification device according to claim 1 in combination with a detection apparatus, the detection apparatus comprising:
a. locating means for locating the identification device on an article,
b. at least one reading means separate from the locating means, wherein the reading means includes an atomic force microscope or other micro computerised measuring machine, and
c. central means operable to control the reading means to read the codes.

17. An identification device according to claim 1 provided on one of:
(1) a currency banknote, or
(2) a security paper.

18. An identification device according to claim 1 provided on one of:
(1) a gemstone, or
(2) jewelry.

19. An identification device according to claim 9 provided on one of:
(1) a currency banknote, or
(2) a security paper.

20. An identification device according to claim 9 provided on one of:
(1) a gemstone, or
(2) jewelry.

21. An article including a machine-readable message thereon, the message encoding predetermined information, wherein the message is defined by elements which:
a. are sized sufficiently small to be invisible to the naked eye,
b are arrayed along the article,
c. protrude from the surface of the article, and
d. vary in one or more machine-readable characteristics, wherein such variation in characteristics encodes the predetermined information.

22. The article of claim 21 wherein the elements have at least substantially similar shape but vary in one or more of their:
(1) spacing,
(2) height dimensions,
(3) width dimensions, and
(4) length dimensions,
wherein such variation encodes the predetermined information.
